(19) United States
(12) Patent Application Publication
(10) Pub. No.: US 2015/0161200 A1
(43) Pub. Date: Jun. 11, 2015

(54) SYSTEM AND METHOD FOR ENTITY-BASED SEARCH, SEARCH PROFILING, AND DYNAMIC SEARCH UPDATING

(71) Applicant: PLACESTER, INC., Boston, MA (US)

(72) Inventors: Matthew Barba, Boston, MA (US); Frederick P.D. Townes, Boston, MA (US)

(21) Appl. No.: 14/535,886

(22) Filed: Nov. 7, 2014

Related U.S. Application Data
(60) Provisional application No. 61/909,606, filed on Nov. 27, 2013.

(51) Int. Cl. G06F 17/30; G06Q 50/16; H04L 29/08

(52) U.S. Cl. CPC G06F 17/30386; H04L 67/22; G06Q 50/16

(57) ABSTRACT

Various aspects and embodiments are related to an information retrieval and information sourcing architecture. The information retrieval and sourcing architecture can be implemented in a real estate setting. For example, the architecture can be implemented in the real estate setting to provide intuitive search results dynamically ranked according to user model personalizations. Dynamic recommendations can be generated within any environment (e.g., real estate information environment). Additionally, recommendations can be dynamically provided to a user in the form of search results outside the requested results set —and these expansions/recommendations can be based on likely engagement of the user with the results. Likely engagement can be determined by a search system based on profiling (even anonymous users) and matching user models to the current user. The system can execute discovery operations which feed search results proven engaging to other users or have a likelihood of favorable engagement based on user modeling.

### CROSS REFERENCE TO RELATED APPLICATIONS

This application claims priority under 35 U.S.C. §119(e) to U.S. Provisional Application Ser. No. 61/909,606 entitled “SYSTEM AND METHOD FOR ENTITY-BASED SEARCH AND RECOMMENDATIONS FOR REAL ESTATE DATA SETS,” filed on Nov. 27, 2013, which is incorporated herein by reference in its entirety.

### BACKGROUND

There are many different systems for searching for information, and for example, searching information in a real estate setting. For instance, there are a number of real estate websites (e.g., Zillow, Realtor.com, etc.) that permit users to perform a real estate search (e.g., for the purpose of locating relevant homes for sale). Such searching usually involves a query that is formed by a user by operating an interface with dropdown menus and selection buttons. Users might, for instance, perform a search by specifying a zip code for searching, select some predefined price range and other selections within the interface, and select an interface control to initiate a search.

Further, there are general purpose search engines (e.g., Google) that provide access to all types and kinds of data including, real estate data, however, the results of such searches are usually no more meaningful than the results provided by specialized real estate websites, as they generally include other information not related to real estate listings and are not optimized for real estate searches. For instance, a search phrase “San Francisco homes for sale” might retrieve other information about San Francisco real estate in addition to any real estate listing information. Similar to the real estate websites mentioned above, users do not know the structure of the underlying data set of the general purpose search engine and therefore, they cannot predict how a particular input might affect a search result.

### SUMMARY

However, it is appreciated that many user searches are imperfect in that the user has to have some knowledge of the database or source they are looking to access in order to actually find meaningful results. Many of these searches are performed recursively, wasting time and effort of the user, often with mixed results.

Stated broadly, various aspects and embodiments of the invention are related to an information retrieval and information sourcing architecture. In some embodiments, the information retrieval and sourcing architecture is implemented in a real estate setting. For example, the architecture can be implemented in the real estate setting to provide intuitive search results that, for example, are dynamically ranked according to user model personalization. Employing the architecture, dynamic recommendations can be generated within real estate information environment. In some examples, recommendations can be dynamically provided to a user in the form of search results outside the requested results set —and these expansions/recommendations can be based on likely engagement of the user with the results. Likely engagement can be determined by a search system based on profiling users (even anonymous users) and matching user models to the current searching user. In further embodiments, the system can execute discovery operations which feed (e.g., display) search results that have generally proven engaging to other users or have a likelihood of favorable engagement based on user modeling.

In some embodiments, search results can be matched by the system to a current user and personalized based on behavioral analysis and/or intent profiling of the user, the user's entered information, search terms, user activity and/or landing content (e.g., previous computer actions (e.g., click history, web page trail, etc.) that led the current user to the search system. In some examples, the user can be directed to a landing page based on targeted traffic acquisition. In further embodiments, the search system can be configured to automatically purchase user traffic such that the user traffic is directed to a landing page selected by the system. Further, the architecture of the landing page can be customized dynamically by the system to improve engagement with system selected content (e.g., automatically placed advertising, automatically arranged content, etc.) and further tailored to individual users as they reach the landing pages. In some embodiments, tailoring of the page can be based on user modeling and/or intent profiling, among other options.

According to various aspects and embodiments, a search system can be implemented in a real estate setting where the search system can be optimized to process real estate data for any of search, retrieval, and/or recommendation functions responsive to user input. According to one embodiment, the system is configured to integrate with existing real estate data systems or integrate existing real estate data to provide a standardized platform from which user based free text searching can be performed. According to another aspect, it is appreciated that free text search provides unique challenges in the real estate space. In particular, it is realized that real estate data can be highly structured and/or organized such that conventional free text search yields unfocused and even mismatched results.

According to one embodiment, a search system is provided that is configured to identify keywords in input search terms, provide word stemming, synonym matching, etc., in a similar manner as compared with conventional search functions. However, according to one embodiment, the system can be configured to use keyword match information to identify relevant data entities within the data sets. In some examples, the system can be configured to identify relevant data entities in the data set and emphasize those data entities to return results that are contextually focused and represent intuitive insights into the data set.

In one example, a free text input entered through a conventional system “Eat in Boston” may result in a first result display of a property in Boston Township line, Richmond Ind. (See FIG. 1). It is realized that without incorporating entity-focused searching, confusing, mismatched, and irrelevant results are returned responsive to free text searching. In one example, the current system is configured to identify “Eat in” as a property of a data entity “Kitchen,” and is further configured to recognize “Boston” as an attribute of a location entity. By focusing search on these identified entity matches, the system can be configured to return intuitive results, delivering, for example, property matches in Boston with eat in kitchens. According to some embodiments, entities within the data sets can be weighted to emphasize specific sets of results having matching entity attributes. In some embodiments, entity matching made greater efficiency in search of retrieval. Further, entity based searching improves computational performance over conventional approaches.

In various aspects, the search system can be configured to capture and integrate existing data (e.g. real estate data) into a defined organization based at least in part on data entity elements that are standardized within the data. For example, a multitude of real estate systems and/or data can be processed into entity based data records. In one example, the system can include customized application programming interfaces (“APIs”) to make existing data available on the search system. In some embodiments, the system can capture and/or incorporate existing data through the APIs. Some existing real estate systems include multiple listing service (“MLS”) databases, and various embodiments of the present invention may receive and process MLS data from multiple sources.

In various embodiments, the search system can also provide predictive geo-search functions configured to analyze user location and/or an intended search location to increase relevancy of results returned to user. In some examples, the geo-search functions can be incorporated as functional displays in user interface components displayed by the system to end users. In another embodiment, the system is configured to dynamically rank search results. In some examples, the system can include machine learning processes to generate curation of returned result sets. The curated results can be used to predict results to return to a searching user. In some embodiments, the curated results are personalized to the searching user, even if the searching user is anonymous or not identified on the system (e.g., intent and behavior modeling can be applied to anonymous users). The personalization can be based on properties of the user, and in further examples, can be based on predictions of the user's interaction with search results derived from machine learning processing.

In some embodiments, the curation of the result set by the system can also be used to generate, dynamically, recommendations outside the current results set and discover potential new results. In some examples, the system can test or determine a likelihood of user engagement with system identified results based on generic engagement information (e.g., not specific to the user but generally identified as likely to be engaging). Further, the system can provide user access to the curated attributes enabling the user to filter, create data facets (e.g., data or data descriptions attributes), and sort search results across multiple and/or any data dimensions available in the result set. The tested results can be used to augment predictions of user behavior and/or responsiveness to system selected results, system selected display positions, system selection user interface design, etc.

Further embodiments of the system can include behavioral analysis of user actions (e.g., search terms, search navigation, web history, web trail, user activity modeling, result accesses, result views, results hovers, among other options) and/or intent profiling. According to some embodiments, the system can provide search interface customizations based on the searching user, determined user intent, matching user modeling, etc.

According to some aspects the search system can be implemented as part of an information platform. The information platform can be configured to extend available information beyond conventional search boundaries. For example, in the real estate setting, many proprietary search services exist, which provide specialized data and searching within specialized database repositories to attempt to return relevant results (e.g., Zillow, Trulia, and Realtor.com). The information platform can be configured to leverage specialized data sets/databases and augment the specialized data with broader information sets. In some examples, the augmented data sets are associated with user behavior information. Thus, the system is configured to predict how a user will interact with a given result, result set, display, selection options, etc., and customize search results and search interfaces accordingly.

According to some embodiments, the information platform can be configured to capture and normalize third party data into canonical data entities and/or attributes. The search functions can then leverage specialized data sets, and incorporate third party information into broader/exhaustive search result sets. In some embodiments, the information platform is configured to process any raw data format and integrate raw data formats into canonical data entities for use in search functions, modeling, and/or customization. The system can identify and generate relationships between third party data and first party data captured on the information platform. In some examples, purchased web traffic can also be used to generate analysis information that yields further relationship information, user modeling, and/or intent modeling.

In further embodiments, user modeling and/or intent modeling enables additional refinements in content presentation. For example, user's search criteria and/or behavior modeling can be used to select content (e.g., advertising) that will appear on a web-page viewed by the user. The arrangement of the content can likewise be tailored to the user, user model, and/or context in which the user arrives on a given page. In some embodiments, the information platform is configured to host a plurality of online resources (including, for example, web pages). In some examples, the information platform provides content publishing services via the hosted pages. The information platform can be configured to integrate various data sources having a variety of formats into readily accessible/searchable information from any hosted solution. In some embodiments, the processing of various data formats ensures data portability between the various hosted solutions.

According to another aspect of the present invention, a system is provided that provides tools for behaviorally targeting users responsive to searches (e.g., real estate searches) and their associated data. According to one embodiment, it is appreciated that in one environment a search system may provide more effective real estate search results to users over time in response to their behavioral data. For instance, a real estate system may collect over time search information provided by users, analyze signals within their search data, and develop search profiles for individuals and certain kinds of users. Further, insights within the data itself may be captured by heuristics that can yield more effective search results, all with the goal of determining the search intent of the user and representing the most relevant matched listings for a particular search input and user.

According to one aspect, a system for entity based searching within a real estate database is provided. The system comprises at least one processor operatively connected to a memory, an interpreter component, executed by the at least one processor, configured to receive search information based on a free text input by a user, and interpret the free text search information, an analysis component configured to match data entities in the real estate database against the interpreted free text search information, wherein the data entities include at least a descriptor for real property and a value associated with the descriptor, and wherein the at least one processor is further configured to constrain search execution within the real estate database based on the matched data entities and return results from properties having the matched data entities.

In one embodiment, the interpreter component is further configured to identify a data entity and an associated value based on only free text. In one embodiment, the interpreter is configured to interpret a free text term to identify a data entity and a preferred value associated with the data entity. In one embodiment, the interpreter is further configured to identify a range of values associated with the data entity.

According to one aspect, a method for entity based searching within a real estate database is provided. The method comprises receiving, by a computer system, search information based on a free text input by a user, interpreting, by the computer system, the free text search information, matching, by the computer system data entities in the real estate database against the interpreted free text search information, wherein the data entities include at least a descriptor for real property and a value associated with the descriptor, constraining, by the computer system, search execution within the real estate database based on the matched data entities, and returning, by the computer system, results from properties having the matched data entities.

In one embodiment, the method further comprises identifying a data entity and an associated value based on only free text. In one embodiment, interpreting includes an act of interpreting a free text term to identify a data entity and a preferred value associated with the data entity. In one embodiment, the method comprises identifying a range of values associated with the data entity.

According to one aspect, a system for determining search intent is provided. The system comprises at least one processor operatively connected to a memory, a search analysis component, executed by the at least one processor, configured to receive any one or more of search information, returned results, and accessed results returned from a real estate database, determine user intent based on the any one or more of search information, returned results, and accessed results, wherein the data entities include at least a descriptor for real property and a value associated with the descriptor, correlate the user intent to data entities having respective values based on and wherein the at least one processor is configured to modify subsequent search execution within the real estate database based on the user intent information.

In one embodiment, the at least one processor is configured to assign a weight to a data entity responsive to the determination of the user intent. In one embodiment, the at least one processor is configured to interpret free text input into a data entity based at least in part on user intent information. In one embodiment, the at least one processor is configured to generate an interpretation rule for subsequent search execution. In one embodiment, the at least one processor is configured to assign a weight to a respective data entity and respective value associated with the data entity.

Still other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. Where technical features in the figures, detailed description or any claim are followed by references signs, the reference signs have been included for the sole purpose of increasing the intelligibility of the figures, detailed description, and claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1 is a screen capture of a convention real estate search interface;

FIG. 2A is a block diagram of a system for entity based searching, according to one embodiment;

FIG. 2B is a block diagram of a system for entity based searching, according to one embodiment;

FIG. 3 is a system for searching real estate listings, according to one embodiment;

FIG. 4 is an example process for performing searching and recommendation, according to one embodiment;

FIG. 5 is a block diagram for generating user intent, according to one embodiment;

FIG. 6 is a block diagram of one example of a computer system that may be specially configured to perform processes and functions disclosed herein;

FIG. 7 is a block diagram of a computer data storage system with which various embodiments of the invention may be practiced;

FIGS. 8A-B are a block diagram of data flow and processing, according to one embodiment; and

FIGS. 9-15 are example screen captures of user interfaces according to various embodiments.

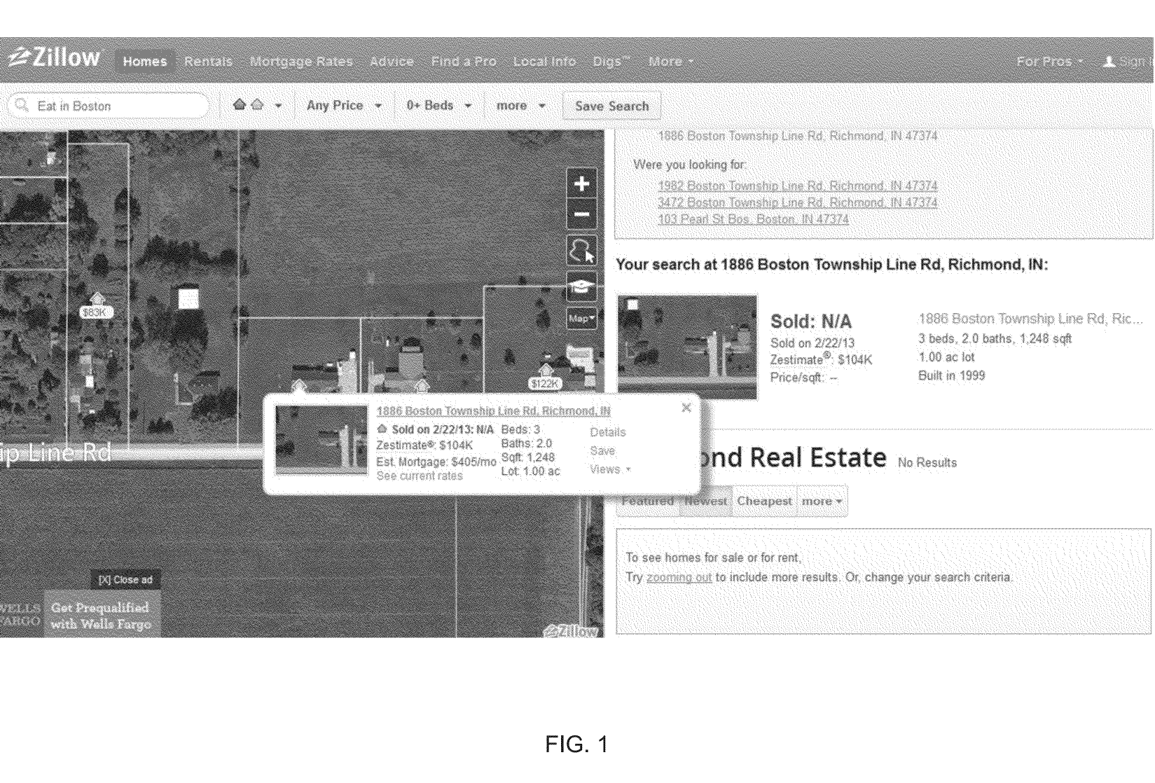

### DETAILED DESCRIPTION

According to one embodiment, a distributed search system is provided to enable free text searching within a variety of data settings including information environments that include one or more real estate databases. In some embodiments, free text input is interpreted by the system to identify respective data entities within the real estate database. Data entities can be descriptors or groups of descriptors for real property, and further the data entities can be associated with a value that describes a respective property. According to one embodiment, the system is configured to interpret free text input to identify relevant data entities. The system can be configured to constrain search execution based on the data entities to return, for example, contextually relevant results.

In further embodiments, the system is configured to analyze any one or more of: interpreted search information, returned results, and/or user activity associated with the returned results. According to one embodiment, analysis of the interpreted search information, returned results and/or the user activity generates user intent information. In one example, the system can associate intent information with data entities to modify returned search results. For example, the system can generate rules such that “studio” as a free text input is interpreted as a bedroom entity (e.g., an entity describing a number of bedrooms within a real property) having 1 or 2 bedrooms. The system can also be configured to associate identified user intent with entity-value combinations, among other options. In another embodiment, the intent information can be used to generate weighting information for any one or more of data entities, associated values, and/or ranges of values. The weighting information can then be used to influence results returned by the system.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

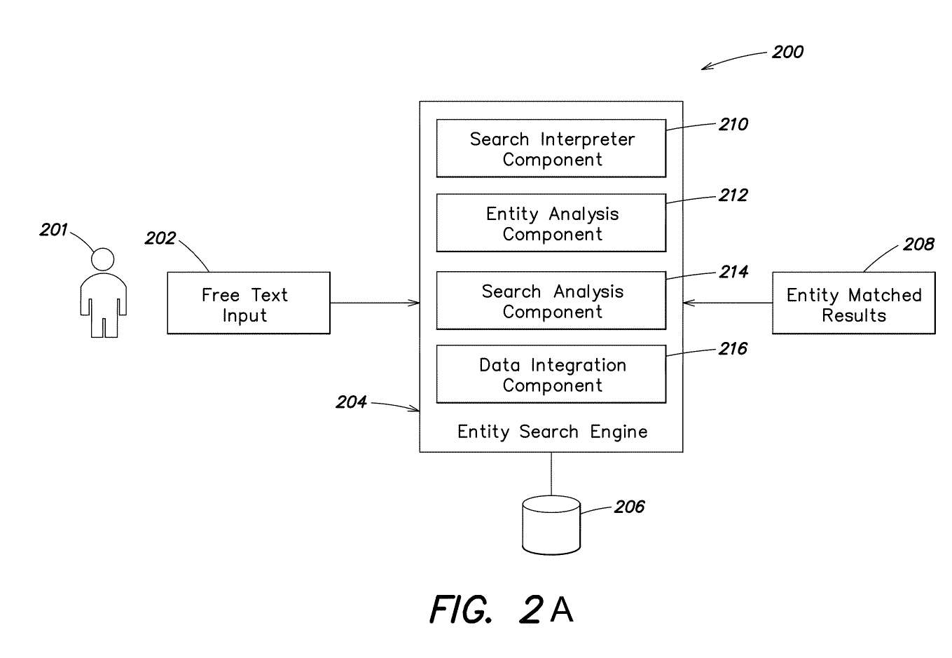

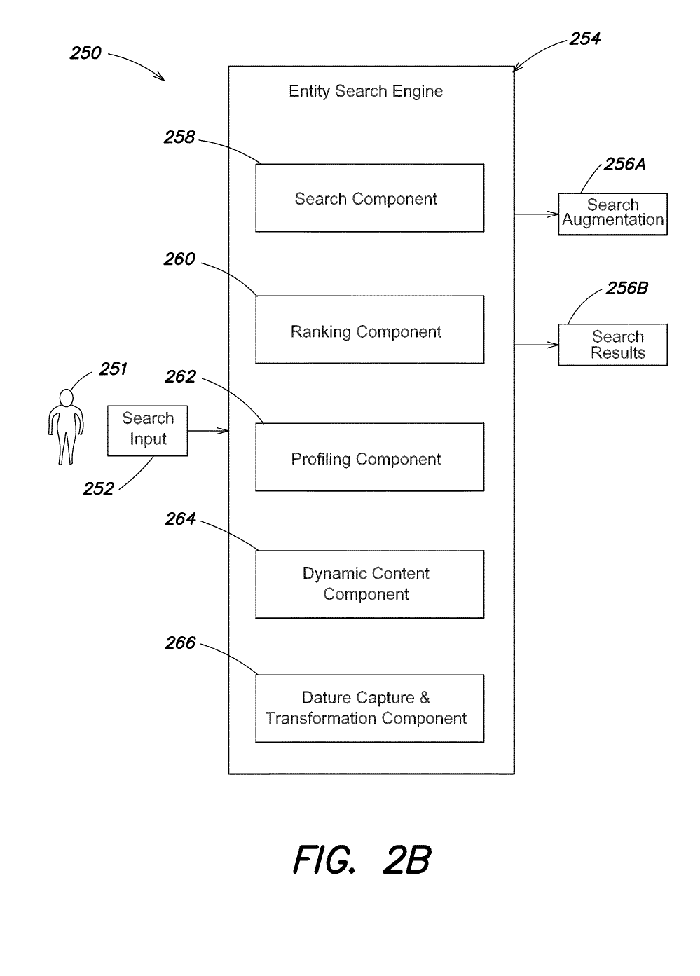

FIG. 2A shows one embodiment of a system 200 for entity based search. A user 201 operating a computer and interface may access system 200 for the purpose of searching real estate listings. System 200 may include a number of components that permit the user 201 to access and search various property listings, rental properties, available land, among other options. According to some embodiments, the system 200 can interpret free text input 202 submitted by users 201 using an entity search engine 204. The entity search engine can be configured to interpret the free text input for words, word stems, synonyms, etc., in order to identify likely search terms, candidate search terms, etc. The entity search engine 204 can be configured to evaluate the interpreted search information (e.g., exact terms, likely search terms, candidate terms, etc.) to identify data entities within a database, for example, of real estate information 206. Once the entity search engine 204 has identified matching entities from the interpreted search information, the engine 204 can return results 208 from the database 206. In one example, the engine 204 is configured to constrain searches executed on database 206 based on the identified data entities. According to some embodiments, data entities can also be associated with respective weightings, such that search execution favors entities with a higher weighting. In further embodiments, the system is configured to expand returned search results based on the identified data entities. In further examples, the search results can be dynamically ranked and/or filtered based on data entities within a search knowledge base.

According to one example knowledge base including real estate data, the highest weightings are assigned to a location entity (e.g., a data element specifying location for the data object), a bedroom entity (e.g., a data element specifying a number of bedrooms a property includes), and a price entity (e.g., specifying an asking price, rental price, etc. for a property). According to one embodiment, the tuple of highest weighted entities enables the system to efficiently and unambiguously match the user's desired search results. Further, the matching based on entity enables the system to respond to free text input that conventional approaches cannot resolve. For example, “2 bed Boston” is first interpreted by the system for keyword matches, synonym matches etc., to establish interpreted search terms (e.g., “bedroom” and “bed”). The interpreted search terms are matched to data entities within the data. In one example, each property listing is stored as a property object and/or a property document. Each property object can include, for example, entity data “bedrooms,” “location,” and “price,” among other options. Each data entity can be associated with descriptive information on the respective property objects (e.g., “Bedroom—5 Beds” and “Location—Boston”). The descriptions associated with the entities are then matched to yield relevant results (e.g., 208) responsive to the free text search (e.g., 202).

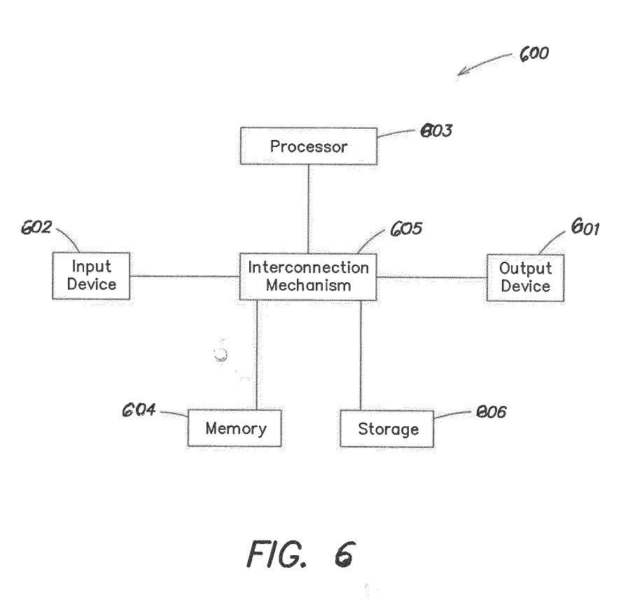

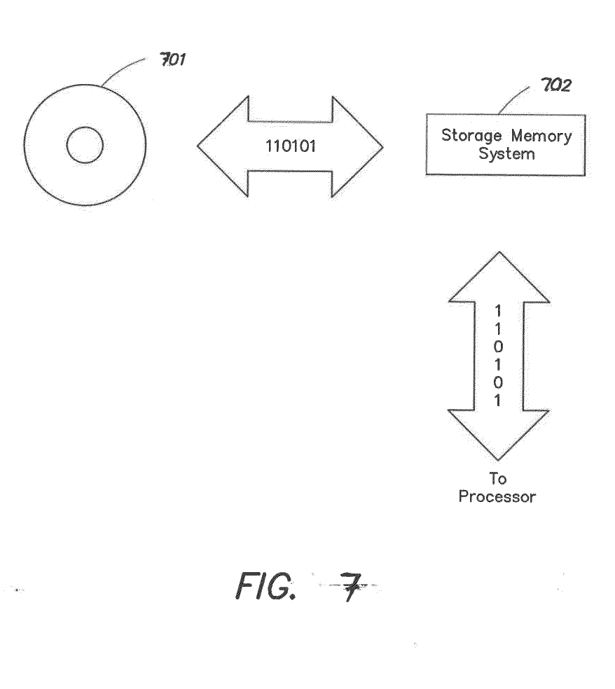

According to one embodiment, system 200 can generate results 208 using engine 204. The engine 204 and/or elements of the system 200 can be implemented using a specially configured system such as the computer system 600 described with reference to FIG. 6. In some implementations, the system 200 and/or engine 204 can include system components specially configured to execute functions within the system. Described below are example system components and functions, however, in other embodiments, the functions described can be executed by different system components or distributed across one or more system components.

In one embodiment, the system 200 includes an interpreter component 210. The interpreter component can be configured to accept a free text input received from a user, and interpret the free text input to identify key words. The component 210 can also be configured to interpret the free text input to identify word stems, word synonyms, etc. as is known in the art. Once the interpreted search terms have been identified the interpreter component can pass the interpreted search terms to an entity analysis component 212.

According to one embodiment, the entity analysis component 212 can be configured to match defined entities within a real estate database (e.g., 206). The defined entities can be used to focus search execution on the database. In particular, matches entities are searched for matching attribute values contained in the interpreted search terms. Additionally, the entity analysis component 212 can be configured to further interpret a user's desired search criteria based on analysis of the matching entities and attribute information.

In one embodiment, the system can include a search analysis component 214. The search analysis component can be configured to analyze executed searches and return results to identify intent information. In one example, the system is configured to learn that searches executed on “Studio” are associated with a property having a bedroom entity and an associated value of 2 or 1. In some embodiments, the analysis component 214 includes machine learning functions to correlate search terms, identified entities, and/or search results with a user search intent. For example, the system can be configured to determine that a search executed on “pool” and “hardwood” is correlated to single family homes in the top price quartile for a respective location. The analysis component 214 can be configured to supply the correlation information to augment search results. Further, the analysis component 214 can be configured to augment entity matching by the entity analysis component 212 based on prior search execution.

According to some embodiments, the system 200 can be integrated with existing data repositories for real estate data. The data accessed by the system (e.g., illustrated as database 206) can include information stored on other systems and/or data captured from other system, among other options. In one embodiment, the system can include an integration component 216 configured to access and/or capture real estate data from external systems. According to one embodiment, the integration component can include an integration engine that includes specialized data drivers and settings to access real estate information as a data feed from a data source.

In one example, a data source can be a MLS repository, and the integration component 216 and/or engine can access the systems associated with the MLS repository to capture data for storage in database 206. In another example, the integration component 216 can access the data stored on the MLS repository in real time, responsive to user input free text queries. Returned results can be stored in database 206, for example, to reduce subsequent retrieval times. Various external data sources can each be associated with a custom driver and/or custom data specification to enable the integration component 216 to capture external data and store that information within the system (e.g., in database 206). According to another embodiment, the integration component 216 can include custom APIs for connecting, interacting, and/or retrieving data from real estate data repositories (e.g., MLS services). According to one embodiment, the documents and media that the system indexes are not subject to usage guidelines and, for example, are publicly available and optimized for indexation. In further embodiments, the system executes custom ingestion processing through which the system is configured to migrate and operate on raw data from various external resources.

FIG. 2B illustrates a block diagram of another example embodiment of a system 250 for augmented search and result delivery. A user 251 operating a computer and interface may access system 250 for the purpose of searching, for example, real estate listings. System 250 may include a number of components that permit the user 251 to access and search various property listings, rental properties, available land, among other options. According to some embodiments, the system 200 can interpret search input 252 (e.g., free text input) submitted by a user 251 or users using an entity search engine 254. The entity search engine 254 can be configured to interpret the free text input for words, word stems, synonyms, etc., in order to identify likely search terms, candidate search terms, etc.

System 250 can provide any of the functionality discussed above with respect to system 200. In some embodiments, system 250 can also provide features to augment user interaction (e.g., at 256A) for example with any of location information, behavior modeling and search focusing, user interface visualization, and optimizing user search for speed and scalability. The system 250 can present results (e.g., 256B) in user interfaces customized to the searching user. In some embodiments, the system can customize and/or augment search functionality presented the current user (e.g., 251) based on any one or more of modeling the user, determining the user's search intent, matching data entities to the user's search input, among other options.

According to various embodiments, the entity search engine and/or system 250 can include or instantiate a variety of sub-components configured to execute specialized functions on the system 250. In other embodiments, the entity search engine 254 and/or system 250 can be configured to execute the specialized functions directly. According to one embodiment, the system 250 and/or engine 254 includes a search component 258 configured to interpret search inputs received from a user. The search component can be configured to receive, for example, free text input and match the search input to data entities within a knowledge base (e.g., a real estate knowledge base). The search component 258 can be configured to provide type forward recommendations in response to matching data entities. Further, type forward recommendations can be based on intent profiling and/or user modeling.

In some embodiments, the system is configured to predict user behavior associated with candidate search results. For example, the system can identify specific results within a search result set or even augment the initial results in a search result set based on how the searching user is expected to behave when presented with those search results. In further embodiments, the system is configured to customized user interface tools to facilitate user interaction with the search result set. For example, the system can dynamically predict a specific search result that would be the most favorable to the user (e.g., in terms of expected behavior of the searching user when presented with the most favorable result). Based on behavioral modeling the system can predict what result, display position, and in some examples, what user interface element should convey the search result to achieve a predicted behavior from the searching user.

In some embodiments, the search component can also promote type forward recommendations based on generic (e.g., not user matched) recommendation improvements and score the users interaction with the promoted type forward recommendations. If the user interacts with the promoted type forward recommendations (e.g., the system tracks a click, selection, hover, mouse over, etc.) the promoted recommendation can be incorporated into any one or more of a user model, an intent model, an engagement model, among other options for use with subsequent searches and/or users.

According to other embodiments, the search component 258 can dynamically populate search selections based on any one or more of user modeling, intent profiling, behavioral analysis, and data entity matching. The search selections can be configured to provide dynamic and complete search criteria selectable by the user to complete their intended search and/or to provide a search and results with which the current searching user is likely to be engaged. In further embodiments, the search component can also inject additional search selections, and the system can track user interaction with the injected search selections for inclusion into a user model, intent model, entity matching model, etc.

According to another embodiment, the search component can also provide access to automatically generated information facets. In some examples, the information facets provide descriptive information related to the user's search input, returned search results, etc. According to one embodiment, the information facets can be used by the system to augment the presentation of a set of search results for a given user. Further, the information facets can be selected by the system/search component based on an increase in the likelihood of user engagement with the result set and/or the facet-based organization of the result sets.

In some embodiments, the system 250 and/or engine 254 can include a ranking component 260 configured to customize the organization of displayed search results. According to one embodiment, the ranking component is configured to personalize search results returned to each user. In some examples, the personalization can be based on information associated with the currently searching user. In other examples, the system and/or ranking component 260 can infer personalization information on even anonymous users. For example, the ranking component 260 can be configured to personalize returned search results, include personalized result recommendations based on extending a conventional search result set. In further embodiments, the ranking component can be configured to discover new results to recommend based on selectively injecting candidate results and tracking user interactions with the candidate results. The candidate results can be selected by the system and/or ranking component based on generic matching—based on users having less specific criteria than the current searching user the generic results have proven to be engaging.

According to some embodiments, the system can include a profiling component 262 configured to determine how engaging search results are. The profiling component 262 can be configured to model users and/or engagement based on user activity (e.g., pages views, content views, in page selection (e.g., hover, click, dwell time, etc.), browse trail, history, among other options). The profiling component can generate a user model that the system can match to a current searching user. In further embodiments, the profiling component 262 can also model user intent. The system can refine search results return and even content shown to searching users based on any combination of user model, intent model, and/or context information.

According to one embodiment, the profiling component 262 is further configured to uniquely identify human users to capture unique user interactions with searches, search results, data entities (e.g., real estate data entities), among other options. The profiling component can be further configured to use the unique identification of human users and generate relationships between the unique users and data providers. In one example, vendor information is used to augment search results and/or content presented on the information platform. The system and/or platform can be configured to incorporate data providers as a factor in deriving relevance of search results, recommended queries, etc.

In further embodiments, the system and/or profiling component 262 dynamically captures information on a current user and the current users search session to transform the captured data in real time and employ the current user's data in optimizing a result set that can be tailored to maximize the current user's engagement with the delivered search results. In some embodiments, the data gathered during the current user's search sessions is matched with the same user's previous sessions to augment any modeling, recommendation, and/or ranking of content. Further similar users and similar users' search activity can also be used to optimize results sets returned by the system. In one example, the profiling component 262 is configured to execute predictive conversion modeling to tailor results sets that are predicted to be the most engaging to the current users. In some examples, the current search session can be analyzed against the predictive model to refine the model of the current users and/or similar users.

In yet other embodiments, the profiling component 262 can be configured to profile a current user, their engagement, and likely behavior. In one example, the system 250 analyzes the generated user profiles to identify other users of value. The system can automatically purchase user traffic and direct that user traffic to a system selected web-site based on the user profile. In some embodiments, the system can automatically identify traffic to purchase based on any one or more of user intent profiling, user activity profiling, user behavior analysis, etc. In some examples, the system 250 identifies users of value and automatically generates a bid value to obtain user traffic meeting the profiled criteria. In some examples, the models and/profiled criteria can be developed by the system based on any user interactions and/or interface events. For example, the system 250 can track scrolling in the user interface, track content that is displayed and/or visualized, clicks, hovers, user input, form entries, form submissions, etc. In other examples, the system 250 and/or profiling component 262 can also track application behavior, showing information overlays, capture user's contact information, bibliographic data, etc. The system 250 and/or profiling component can be configured to use any available activity or event information to build user profiles.

The system 250 can be configured to tailor content presentation to specific users (e.g., based on profile). For example, purchased traffic users can be presented unique interface displays and organizations based on profiling of likely engagement with content and/or content organization. In some embodiments, the system 250 can include a dynamic content component 264 configured to tailor content to any one or more of the specific user, user model, modeled intent, etc. In other embodiments, the dynamic content component 264 can be configured to dynamically select and arrange content based on matching data entities to a searched knowledge base (e.g., a real estate knowledge base). In other examples, component 264 can incorporate data entities into content tailoring based on any one or more of the specific user, user model, modeled intent, predictive engagement, etc.

In some embodiments, the dynamic content component 264 is configured to provide an experience to each user that is dynamically optimized that specific user's engagement with the displayed page. In further embodiments, the content can be optimized for whatever device the user is using to access the content (e.g., browser, device, display screen, touch screen, user interface, etc.). The content component 264 can also be configured to customize user interface displays and any displayed interaction tools. For example, drop down menus can be tailored to the user's intent by listing completed search queries based on a determined user intent. In other examples, input fields can be tailored to the user, the user's intent, a matching user model, etc.

In various embodiments, an entire responsive page (e.g., landing page, search page, hosted page, etc.) provided on the information platform or by the system can be customized to the user accessing the page. In the real estate setting, geo-search interfaces can be tailored to the locations that the user wishes to search. Customized user interface mappings can be presented to facilitate user access, for example, to real estate data in the real estate knowledge base. Additional selections can be customized to the user/data environment. In the real estate setting, customized drop down selections can be presented according to user information, user modeling, user intent, user behavior, etc. The customized drop down selections can include interactive listings that when selected direct the user to property details. The customized drop down can be dynamically refined during the user's search, such that selection within the drop down are regenerated by the system based on user activity, updated user profiling, and in further examples based on updated data entities.

According to some embodiments, the system can also include a data capture and transformation component 266. Any user activity that is engaged in on the information platform or accessible to the search system can be used to further refine user profiling and/or data profiling (e.g., data entity matching, data entity creation, relationship creation, etc.). In some embodiments, the data component 266 is configured to recognize data entities within a searchable knowledge base based on identification of search criteria and meaning to the current user. The component 266 can be configured to identify intent terms in user input and any semantic meaning of those terms relevant to the user's search perspective. In the real estate content, this can include identifying a user free text input of “studio” as a free text input to be interpreted as a bedroom entity (e.g., an entity describing a number of bedrooms within a real property). In further examples, the system/data component 266 can further identify the bedroom entity as having 1 or 2 bedrooms based on the input “studio.” The system/component 266 can also be configured to associate identified user intent with entity-value combinations, among other options.

In addition to recognizing data entities to facilitate/customize user search the data capture and transformation component 266 can be configured to create data entities and generate relationships between data entities/data elements as user activity information is captured. In further embodiments, the data component 266 can be further configured to ingest raw data (i.e., process raw data) into entity based data formats. Thus, data component can process raw data from any source, including third party data sources, and transform the data so that is optimized for search on the information platform or by the search system. The data component 266 can also be configured for error correction and normalization of raw data formats. According to some embodiments, the data component 266 processes raw data formats such that any data attribute can be incorporated into searchable data entities, and also be normalized such that machine learning processing can be executed by the system. The canonicalization of the data from whatever source provides an exhaustive search set, while yielding relevant results in whatever knowledge base the user wishes to access.

According to some embodiments, any combination of (e.g., one, two, three, four, five, six, etc.) entity matching to user intent, behavior profiling, tailoring content specific user, user modeling, modeling of intent, predictive engagement assessment can be executed by the search system or on the information platform to increase the efficiency of the search system, reducing computation burden in user based search, reducing computational complexity in tailoring content to specific users. In further embodiments, the systems (e.g., search system and/or information platform) provide unique computational benefits over conventional computers and approaches incorporating automated traffic capture (e.g., via purchase at traffic exchanges e.g., 831), tailoring to users within the purchased traffic, dynamically selecting landing pages for users and customizing the displayed content on the landing pages to the users.

In further examples, the system and/or platform increases operating efficiency of the computer system by capturing necessary traffic to establish usable models. In some embodiments, the system/platform is configured to select traffic to purchase based on analysis of needed behavioral information to attain system specified confidence levels in the user models, behavior models, predictive models, etc. Purchased traffic can also be employed by the system/platform to more efficiently process information than conventional approaches/systems. For example, the purchased traffic can be used by the system/platform to target users, behavior, and/or activity that can be used to validate modeling, test for candidate options (e.g., test new search result recommendations, test engagement response, test placement of content, test landing page selection, landing page architecture), and/or predictions associated with search and/or engagement. If the tracked engagement meets threshold levels, the options can be integrated into behavior models, intent models, etc.

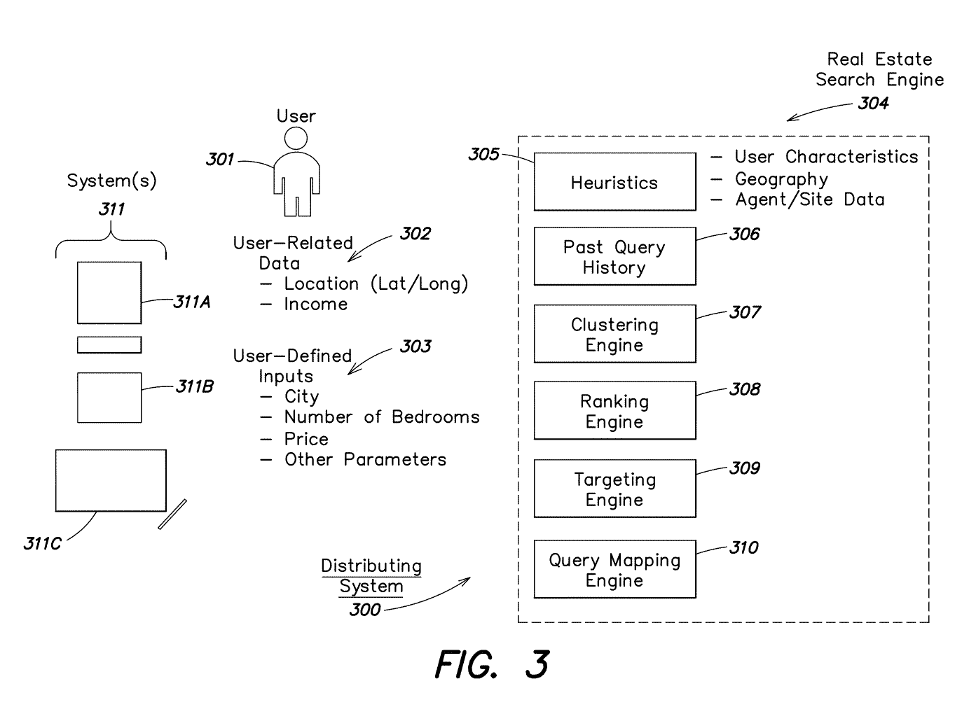

FIG. 3 shows one implementation of a distributed system 300 according to one embodiment of the present invention. For instance, system 300 includes a real estate search engine 304 that may be used to provide real estate search services for one or more users or systems. according to one embodiment, real estate search engine 304 may provide search services to one or more Internet users (e.g., through a browser application), may provide search engine services through one or more application programming interfaces (APIs) to one or more external systems, and/or may be part of an integrated mobile application that is operated by users through one or more mobile devices.

System 300 may use one or more types of data, including user-related data 302. For instance, data relating to user 301 such as the user's location (e.g., as latitude/longitude information as provided by a system 311 operated by the user) may be used as an input to the real estate search engine 304. Other information such as, for example, median income information may be determined based on information provided by the user, or user's system (e.g., by the location of the user). Data may be stored, for example, in any number and types of databases, including, but not limited to, relational databases, object databases, NoSQL-type databases, files, memory, or any other data storage type or structure.

Further, one or more user-defined inputs 303 may be provided by the user to search engine 304. For instance, according to one embodiment, such inputs may be provided as a free text search string provided by the user in a text-based input control of a computer interface. Such inputs 303 include for example, a subject city in which to search, the number of bedrooms associated with a particular real estate location for sale, a price of the location for sale, or any other parameter.

Search engine 304 may include a query mapping engine 310 that receives the query information and maps it to one or more matching data entities and associated attributes. For instance, the text input “1 bedroom” may be mapped to a data entity “number of bedrooms” having an attribute of “1+”.

Further, engine 304 may include a number of other elements that can interpret meaning of the query such as heuristics 305. For instance, it may be interpreted that the term “1 bedroom” may also be an appropriate search for a “studio.” Heuristics 305 may be formed manually or through learning that interprets inputs of users to their intent, stores institutional knowledge of certain geographies, includes any particular knowledge of agents and/or site data, and otherwise includes any experience data that is unknown to the user that may benefit the user in performing a query. Heuristics 305 may store rules and other parameters that can be used by search engine 304 in interpreting the input query, mapping the query to particular input parameters, or interpreting the search data. For instance, metadata analysis may be performed that yields certain heuristics such as characteristics of particular users, the current user, information about a particular geography, information relating to particular site or agents, or other information may be used to affect the outcome of the search. In this way, a specialized search result may be determined for a user based on who they are and what they are searching for based on previous interactions and insights.

Further, search engine 304 may include a past query history 306 that includes information from numerous users relating to past searches and the items which were located. In this way, learning may be applied to previous user searches (e.g., by the current user and/or other users) to improve the accuracy of the search results. Further, search engine 304 may include a clustering engine 307 that may be used to return similar groups of listings that may be appropriate for a particular input. For instance, based on a location, price range, and a number of bedrooms specified, tabular data from a number of MLS sources may be clustered and returned to the user within a user interface. Further, search engine 304 may include a ranking engine 308 that ranks search results responsive to a clustering operation (e.g., as performed by clustering engine 307). For example, if it is determined that certain results within a cluster map most appropriately to an input query, real estate database items that exist within the cluster may be shown more prominently within the user interface.

As discussed, user 301 may operate one or more systems 311 for the purpose of locating real estate database items. For instance, user 301 may want to locate items for sale, rental, or other use. User 301 may operate one or more system types to ask research data such as a computer 311A, mobile device 311B (e.g., a cell phone), a tablet 311C or other device type. According to one embodiment, the interface of such a device may be optimized for display on a number of different types of devices. According to one embodiment, search engine 304 may include one or more interfaces that may be integrated within other websites, such as a real estate agent website, newspaper, real estate magazine, television station or other type of outlet that provides real estate listings.

Further, search engine 304 may include a targeting engine 309 that targets particular real estate entries to a user. For instance, a marketplace may be provided that allows particular real estate database entries to be targeted or highlighted to particular users. For instance, marketing tools may be provided to agents, listers, or other entities that permit particular listings to be displayed to potential buyers. Typically, advertisers for a real estate sales entity can buy impressions, clicks or other actions on a group basis, and thus tools that allow particular seller or agent to highlight particular listings within a multiple-entity marketplace are not available. According to one embodiment, information regarding particular users, their search inputs, and knowledge about the data may be used to target particular real estate entities to a particular user. In this way, real estate entities that are most likely to be viewed and/or purchased by a particular buyer may be presented in the interface.

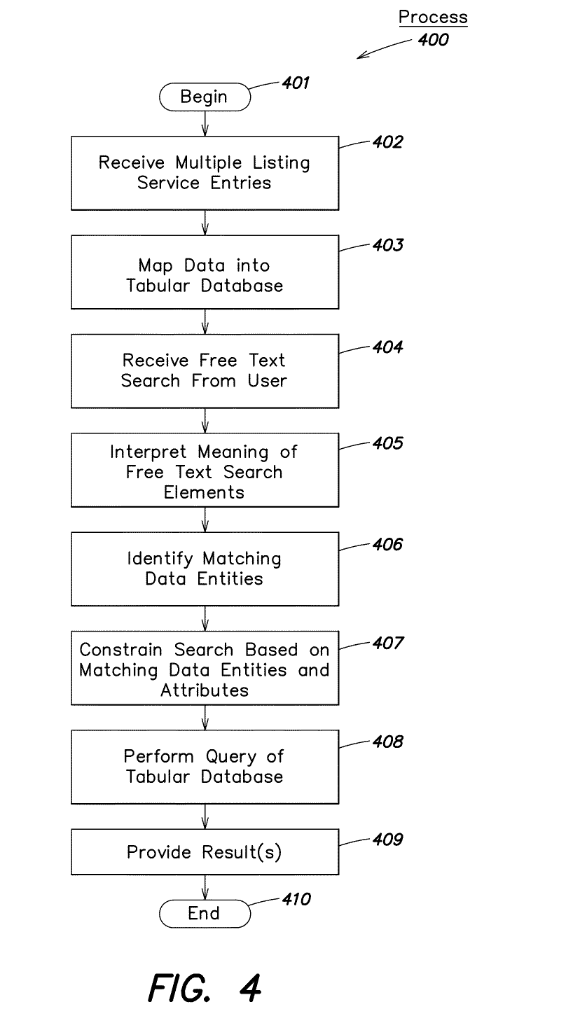

FIG. 4 shows a process 400 performing searching and recommendations in a real estate system according to one embodiment of the present invention. At block 401, process 400 begins. At block 402, a system (e.g., system 300) receives multiple listing service entries from one or more MLS database sources. For instance, such a system may receive MLS data from a number of disparate systems used for accessing MLS data. In various embodiments, at 402 property listings and/or any metadata are captured and processed to augment the relevance of search results for a query executed, for example, on the system (e.g., system 300).

At block 403, the system maps the received MLS data into a database. For instance according to one embodiment, it is appreciated that not all MLS data sources include the same information and therefore, a common view of all MLS databases may be used that incorporates heuristics of multiple data sources into a common data format, for example a tabular database format.

At block 404, the system may receive a free text search from a user. The search text may specify a search to be performed within the real estate database. Such search text may be provided by way of a query input within an interface, application, API, or other input type. At block 405, the system may interpret the meaning of the free text search elements provided by the user. For instance, one or more elements of the free text input may be recognized as particular data entities within the common database format. In one example, the data may be organized into documents, with attribute-value pairs describing the document in which they are contained. According to one embodiment, at block 406, the system may identify matching data entities within the free text search along with any particular attributes specified by the user (e.g., numeric information such as “1”, “2”, “more than 2,” “less than 500K”, qualifiers such as “in the South Farm area”, among others).

At block 407, the system constrains the search based on matching data entities and attributes previously identified. At block 408, the system performs a query of the database (e.g., a tabular database) and provides any results to the user at block 409. At block 410, process 400 ends.

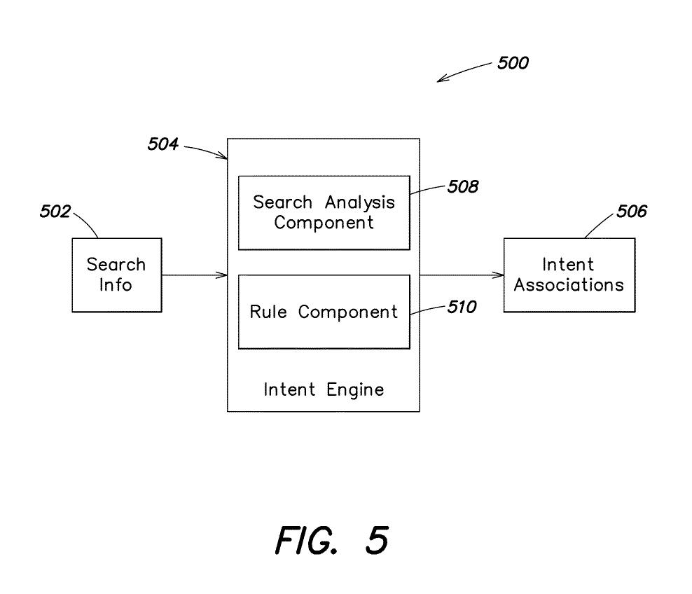

FIG. 5 shows one implementation of a system 500 according to one embodiment. System 500 can be configured to generate user intent information (e.g., 506) from search information (502). In one embodiment, system 500 can employ an intent engine 504 configured to accept search information 502 and generate intent association 506 to store within the system. The intent association 506 can be used to constrain further searches and/or modify results returned in response to search execution.

According to one embodiment, the system 500 and/or intent engine 504 can include a plurality of components for generating intent associations 506. In one embodiment, system 500 and/or intent engine 504 includes a search analysis component 508 configured to analyze any one or more of free text search input, interpreted free text search terms, search results, data entities within the search results, user activity associated with results, etc. (e.g., search information 502). The search analysis component 508 can be configured to identify user intent based on, for example, free text input and the results returned for their search. In some embodiments, the search analysis component 508 can identify trends within the analyzed search information. For example, real estate results returned on “pool” and “hardwood” can be correlated to single family homes in the top price quartile for a respective location (e.g., Boston). Component 508 can identify the trend in the results, and based on the identified trend generate interpretation rules to facilitated search execution.

According to one embodiment, system 500 and/or engine 504 can include a rule component 510 configured to generate interpretation rules for guiding search execution. In some embodiments, the rule component can also be configured to guide identification of data entities correlated to respective free text inputs. For example, the rule component 510 can be configured to associated weights to respective data entities and/or data entity-value combinations, among other options.

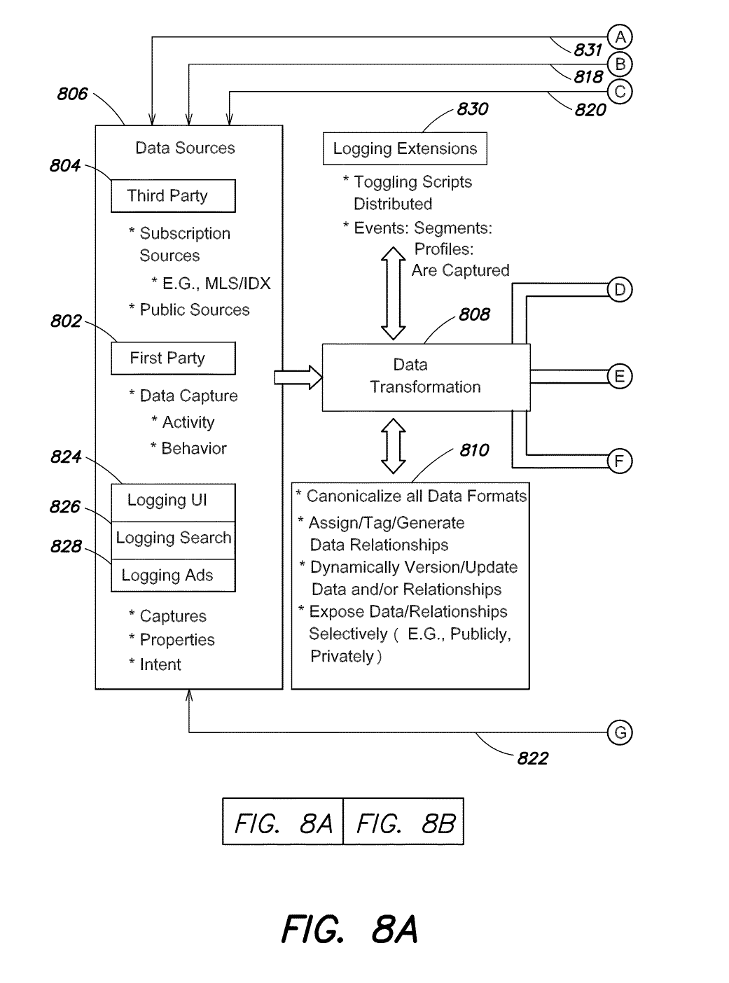

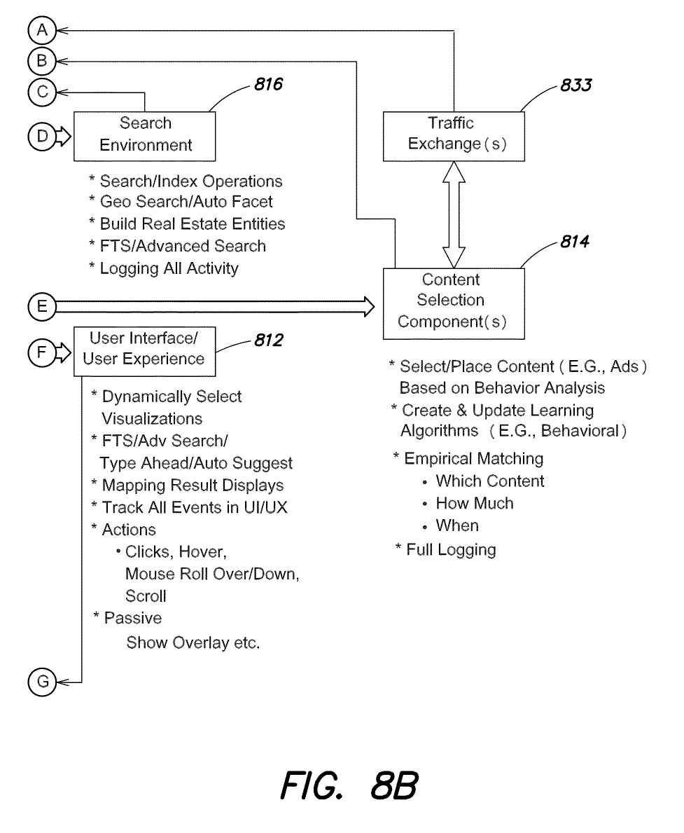

FIGS. 8A-B show a block diagram of data flow and processing operations that can be executed on a search system and/or information platform according to various aspects and embodiments. The data flow 800 shown forms an information cycle, where first party data 802 and third party data 804 (example data sources 806 for an information platform/search system) can be processed by a data transformation component 808 into canonical data entities and/or attributes. The information contained in the data store 810 can be used by the components of the system and/or information platform to augment user content and/or displays (e.g., user interface/user experience component 812—which can customize user experience automatically, for example, based on accumulated data in the data store 810).

In some examples, the content selection component(s) 814 can selectively place content on pages or dynamically assign content for visualization and/or user interaction. In further examples, the content selection component 814 can operate in conjunction with the user interface component 812 to generate and present a unique user experience tailored to each user. In addition, the system/platform provides access to a search environment 816 tailored to the current searching user's intent. In some embodiments, the search environment can be dictated by the system identifying and directing a user to a system specific search environment. In other embodiments, the user selects a search environment (e.g., selects a web site to access and search) and the system/platform tailors the content presented to the user based on identifying the user intent in the content of the search environment being accessed.

The data flow continues from the various system/platform components (e.g., 808, 810, 812, 814, 816) to further expand on available data sources (e.g., 806 and 802). For example, all activity on a hosted site can be logged and processed into the data store 810. In various embodiments, the cyclic nature of the data flow is continually used to refine search results, predictions of user intent, generation of user models (e.g., of user activity, user engagement, etc.). In some embodiments, the system generates candidate selections, candidate data relationships, candidate intent models, and tests the candidate options by injecting the candidate options into the search results or presentation of content to the user. Based on user actions associated with candidate options, the candidates can be included into user models, intent models, and/or identified as engaging to users having matching attributes. In some examples, even anonymous users (e.g., not identified to the system or logged in) can be modeled based on the user's actions on a web site. The fact that the user remains anonymous can even be used to infer behavior for that user.

In some implementations, the search system and/or information platform is provided in the context of hosted web pages, where users access sites hosted by the information platform and/or search system. In some embodiments, publishers or information distributors can subscribe to have their site hosted on the information platform. According to one aspect, by virtue of hosting the web site or online location being accessed and searched, the information platform is able to track all user activity associated with the site which can be used and analyzed to further refine a search experience presented to users. For example, data flows back into the example data sources 806 via tracking of content selection by the users at 818. All content selections can be tracked including for example, hover, visualization, incorporation into a page—whether visualized or not, user scrolling on a page, etc. At 820, all user search selections, search input, etc., can be captured by the system and used to refine data models of user activity, as well as to refine or generate relationships between data entities stored in 810. Any action or event taken by a user in the user interface can be recorded and fed back into data sources 806 for use on the system (e.g., shown by 818, 820, 822, or 833).

In some examples, the user interface can include logging elements (e.g., shown as part of data sources, at 824, as well as other logging elements 826 and 828). The logging elements can be embedded within any hosted site, including, for example, real estate search environments. In one example, 824-828 are illustrated as first party data sources (e.g., under 802). In other embodiments, the system/information platform can also process third party data sources, for example, that are not hosted on the system or information platform. Logging components and/or logging extensions 830 can be distributed to third party sites to extend tracking of user activity to capture the equivalent information as the logging UI 824, search tracking 826, and logging of displayed advertising, incorporated advertising, un-visualized advertising, etc., by 828.

According to another aspect, the data flow and processing 800 can be executed by any embodiment of a search system in any information context or environment. In some implementations, the data flow and processing 800 can occur in a highly structured data environment, for example, a real estate search environment. The data flow and processing executed provides unique advantages to user seeking information in such structured settings. In some examples, the capture data (e.g., user activity, user behavior, search terms, search input, and UI activity) is used to define user models that can be matched to a current searching user. The models enable prediction of what information the user is likely to engage with, that is the information the user wishes to find and can include recommendations that are outside of the user's intended search but are likely to capture the user's interest.

According to one embodiment, the logging elements (e.g., 824, 826, and 828) capture properties of data accessed by the user, interacted with by the user, and can match user models to the current searcher to augment search results. Further, the system can analyze user activity to determine and associate a user's intent to action and/or data. User intent information enables further refinement of search and/or information presented to the searching user. For example, the search environment 816, user interface elements for accessing the environment (e.g., 812), and the content presented (e.g., by content selection component 814), can be dynamically tailored to each user. In some settings, the information platform can create and select unique landing pages for the user to interact with the search system/information platform.

According to one embodiment, the data transformation component 808 accepts raw data from any information source (e.g., public sources, subscription sources, (e.g., MLS data/IDX data, among other options) and integrates the raw data with first party data capture (including, for example, user activity information, user behavior information, data properties, user intent information) to create data store 810. The transform component 808 can be configured to assign, tag, and/or generate data relationships within and between data entities. The data entities and the data store 810 can be versioned dynamically and the updated data used to augment subsequent searching. In some embodiments, the system can selectively expose the collected data and/or selectively exposed sub-sets of the data contain in data store 810. In other embodiments, various sub-sets of the data relationships can be exposed for public use and/or access can be restricted based on data entity and/or data relationship.

According to various embodiments, the developed data relationships can be used on the system to dynamically select visualizations to present to end users. The dynamically selected visualizations can be presented in free text search selections, advance search options, type ahead suggestions or any type of automatic suggest search options. In some embodiments, the dynamic content can include mapping of result displays based on system determined location (e.g., where the user is searching to retrieve information and/or the user's current location).

In further embodiments, the data developed in the data stored can be exposed to other system elements to improve content selection for display to a searching user. In one example, the system/information platform uses intent and/or behavior information on the current searching user to selection advertising content that is most likely to be engaging to the current user. According to one embodiment, a content selection component (e.g., 814) can be configured to accept installation of learning algorithm dynamically to automatically select advertising content according to a subscriber's desired approach to automatically selecting advertisements. In some examples, the system implements machine learning algorithm to predict user behavior based on user models and/or track user activity. In further examples, the system can execute empirical matching to identify what content should be displayed, in what volume, at what time, with full logging of user activity to refine those determinations.

In some embodiments, the system is configured to execute several rounds of transformations or mappings of source data into key:value relationships where the keys are defined based on known data entities with context (e.g., behavioral information). The data entities and associated behavioral information can then be used by the system to determine significance on the values in search, for example, among many other intent-identification exercises. In various embodiments, each application and/or user facing executable available on the information platform is configured to observe of user interaction with displayed elements of a given page (e.g., displayed tool, displayed information, or any other UI visualization) as well as the search criteria to derive intent and engagement. The intent and engagement information is used by the information platform to customize the platform in various settings, including, how a user facing application presents property information.

In one example, a user engages with suggested links to investigate an area (e.g. neighborhood) in a property listing environment. The user can begin by entering a location into a search field and the system directs the user into relevant search results. Search results are presented in a manner consistent with the system inferred intent of the user. A user experience can be customized to each user. In the property listing environment, the system utilizes user interactions (clicks, hovers etc) to determine which property “profiles” are relevant to the searching user and to determine the search results, suggestions and recommendations that better characterize the searching user's intent.

In further embodiments, the system is configured to drive user engagement based on intent information. According to one example, the system matches a current searching user to a user/intent profile that the system can identify from an advertiser's target audience criteria. For example, the system can determine what user profile the advertiser is trying to target, and then determine which users should be presented with a set of ads based on matching the target profile. The determinations can be made in real-time on the information platform, a hosted web site/application, or a 3rd party hosted site/system with associations to the information platform.

In some implementations, the platform/system can be specially configured to handle documents/data entities that are originated by humans and as such require various transformations to both make them indexable for search and to account for quality of such first generation information. In some examples, the system is configured to account for quality of the documents in the system generated index as a factor in weighting relevance. This is quite unlike convention search problems in that conventional search typically has to solve for issues associated with programmatically created content and duplicate content. Ultimately, conventional search approaches implement different features to address these problems, including for example, digital fingerprinting (e.g., authorship information). In the property listing context, the notion of a listing agent or data sources that are derived data-like census data or property sales data—are resistant to these conventional quality concerns, as a result our technology intrinsically a “spam resistant” system.

According to one embodiment, the platform can incorporate one or more explicit quality scores (e.g., an “Agent Rank”) of the documents that listing agents (those agents that are responsible for property in a market) create. The quality scores can be implemented by the system as a factor in a ranking/display algorithm. In some embodiments, the quality scores are normalized against numerous other factors, including, for example, intent. In another embodiment, user location can be used a behavior factor in returning information to user of the information platform. Further embodiments implement social graphs as a behavior modeling factor, and customize the information returned, and even display architecture responsive to behavior modeling. According to some embodiments, the platform/system implements machine learning algorithms to assess user behavior and/or generate models of user intent. In some examples, the learning approaches are configured to classify, cluster, generate graphic models, generate sampling models, generate probability distributions, etc., to build intent/behavioral models.

The processes and functions described above are merely illustrative embodiments of systems that may provide user tools and facilities for direct communication and tracking of digital objects between users. Such illustrative embodiments are not intended to limit the scope of the present invention, as any of numerous other implementations for performing the invention. None of the claims set forth below are intended to be limited to any particular implementation, unless such claim includes a limitation explicitly reciting a particular implementation.

The processes, functions, and/or methods associated with various embodiments, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. According to one embodiment, the computer-readable medium may be non-transitory in that the computer-executable instructions may be stored permanently or semi-permanently on the medium. Such signals may define instructions, for example, as part of one or more programs that, as a result of being executed by a computer, instruct the computer to perform one or more of the methods or acts described herein, and/or various embodiments, variations and combinations thereof. Such instructions may be written in any of a plurality of programming languages, for example, Java, JavaScript, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects and embodiments.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, ARM Cortex processor, Qualcomm Scorpion processor, or any other type of processor. It should be appreciated that one or more of any type computer system may be used to partially or fully automate search return, search interpretation, intent analysis, real estate data integration according to various embodiments of the invention. Further, the system may be located on a single computer or may be distributed among a plurality of computers attached by a communications network. In some embodiments, the functions and features disclosed may be implemented as a cloud-based service over a distributed network of computer systems. In some embodiments, the cloud-based computer resources can execute functionality, respond to input, output requests, etc. The cloud-based resource can include any type of general purpose computer system specially configured to execute the functions, methods, and/or operations described herein.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

A computer system may be a general-purpose computer system that is programmable using a high-level computer programming language. Computer system may be also implemented using specially programmed, special purpose hardware. In a computer system there may be a processor that is typically a commercially available processor such as the well-known Pentium, Core, Core Vpro, Xeon, or Itanium class processors available from the Intel Corporation. Many other processors are available. Such a processor usually executes an operating system which may be, for example, the, Windows XP, Windows Vista or Windows 7 or 8 operating systems available from the Microsoft Corporation, MAC OS X Snow Leopard, MAC OS X Lion operating systems available from Apple Computer, the Solaris Operating System available from Sun Microsystems, iOS Blackberry OS, Windows 7 Mobile or Android OS operating system or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as Java, JavaScript, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Further, on each of the one or more computer systems that include one or more components of a system, each of the components may reside in one or more locations on the system. For example, different portions of the components of system may reside in different areas of memory (e.g., RAM, ROM, disk, etc.) on one or more computer systems. Each of such one or more computer systems may include, among other components, a plurality of known components such as one or more processors, a memory system, a disk storage system, one or more network interfaces, and one or more busses or other internal communication links interconnecting the various components.

FIG. 6 shows an example computer system 600 on which various aspects and/or embodiments may be practiced. FIG. 7 shows an example storage system that may be used. System 600 is merely an illustrative embodiment of a computer system suitable for implementing various aspects of the invention. Such an illustrative embodiment is not intended to limit the scope of the invention, as any of numerous other implementations of the system, for example, are possible and are intended to fall within the scope of the invention. For example, a virtual computing platform may be used. None of the claims set forth below are intended to be limited to any particular implementation of the system unless such claim includes a limitation explicitly reciting a particular implementation.

For example, various aspects of the invention may be implemented as specialized software executing in a general-purpose computer system 600 such as that shown in FIG. 6. The computer system 600 may include a processor 603 connected to one or more memory devices 604, such as a disk drive, memory, or other device for storing data. Memory 604 is typically used for storing programs and data during operation of the computer system 600. Components of computer system 600 may be coupled by an interconnection mechanism 605, which may include one or more busses (e.g., between components that are integrated within a same machine) and/or a network (e.g., between components that reside on separate discrete machines). The interconnection mechanism 605 enables communications (e.g., data, instructions) to be exchanged between system components of system 600. Computer system 600 also includes one or more input devices 602, for example, a keyboard, mouse, trackball, microphone, touch screen, and one or more output devices 601, for example, a printing device, display screen, and/or speaker. In addition, computer system 600 may contain one or more interfaces (not shown) that connect computer system 600 to a communication network (in addition or as an alternative to the interconnection mechanism 605.

The storage system 606, shown in greater detail in FIG. 7, typically includes a computer readable and writeable nonvolatile recording medium 701 in which signals are stored that define a program to be executed by the processor or information stored on or in the medium 701 to be processed by the program. The medium may, for example, be a disk or flash memory. Typically, in operation, the processor causes data to be read from the nonvolatile recording medium 701 into another memory 702 that allows for faster access to the information by the processor than does the medium 701. This memory 702 is typically a volatile, random access memory such as a dynamic random access memory (DRAM) or static memory (SRAM). It may be located in storage system 606, as shown, or in memory system 604, not shown. The processor 603 generally manipulates the data within the integrated circuit memory 604, 602 and then copies the data to the medium 701 after processing is completed. A variety of mechanisms are known for managing data movement between the medium 701 and the integrated circuit memory element 604, 702, and the invention is not limited thereto. The invention is not limited to a particular memory system 604 or storage system 606.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 600 is shown by way of example as one type of computer system upon which various aspects of the invention may be practiced, it should be appreciated that aspects of the invention are not limited to being implemented on the computer system as shown in FIG. 6. Various aspects of the invention may be practiced on one or more computers having a different architecture or components that that shown in FIG. 6.

Computer system 600 may be a general-purpose computer system that is programmable using a high-level computer programming language. Computer system 600 may be also implemented using specially programmed, special purpose hardware. In computer system 600, processor 603 is typically a commercially available processor such as the well-known Pentium, Core, Core Vpro, Xeon, or Itanium class processors available from the Intel Corporation. Many other processors are available. Such a processor usually executes an operating system which may be, for example, the Windows Vista, Windows 7 or 8 operating systems available from the Microsoft Corporation, MAC OS Snow Leopard, MAC OS Snow Lion operating systems available from Apple Computer or UNIX available from various sources. Many other operating systems may be used.

Various embodiments of the present invention may be programmed using an object-oriented programming language, such as Java, C++, Ada, or C# (C-Sharp). Other object-oriented programming languages may also be used. Alternatively, functional, scripting, and/or logical programming languages may be used (e.g., JavaScript). Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented using various Internet technologies such as, for example, the well-known Common Gateway Interface (CGI) script, PHP Hyper-text Preprocessor (PHP), Active Server Pages (ASP), HyperText Markup Language (HTML), Extensible Markup Language (XML), Java, JavaScript, Asynchronous JavaScript and XML (AJAX), Flash, and other programming methods. Further, various aspects of the present invention may be implemented in a cloud-based computing platform, such as the well-known EC2 platform available commercially from Amazon.com, Seattle, Wash., among others. Various aspects of the invention may be implemented as programmed or non-programmed elements, or any combination thereof.

### Example System Interfaces

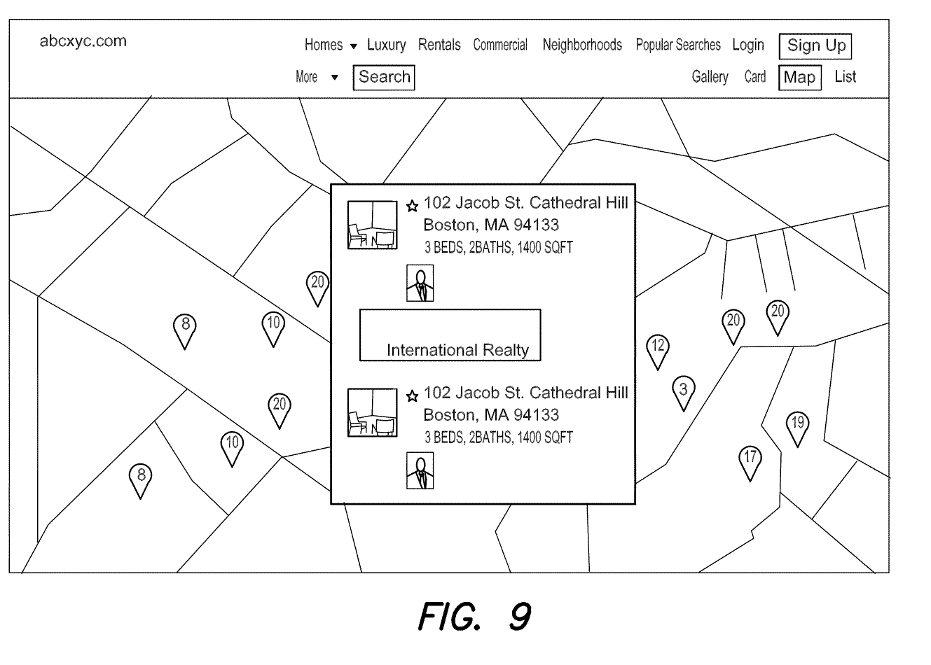

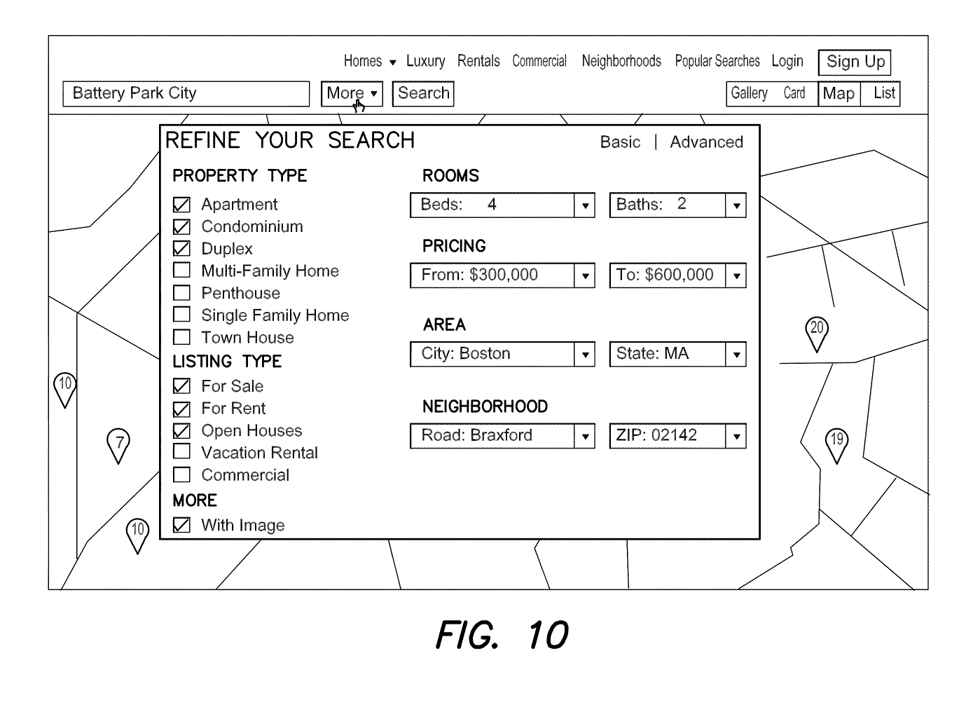

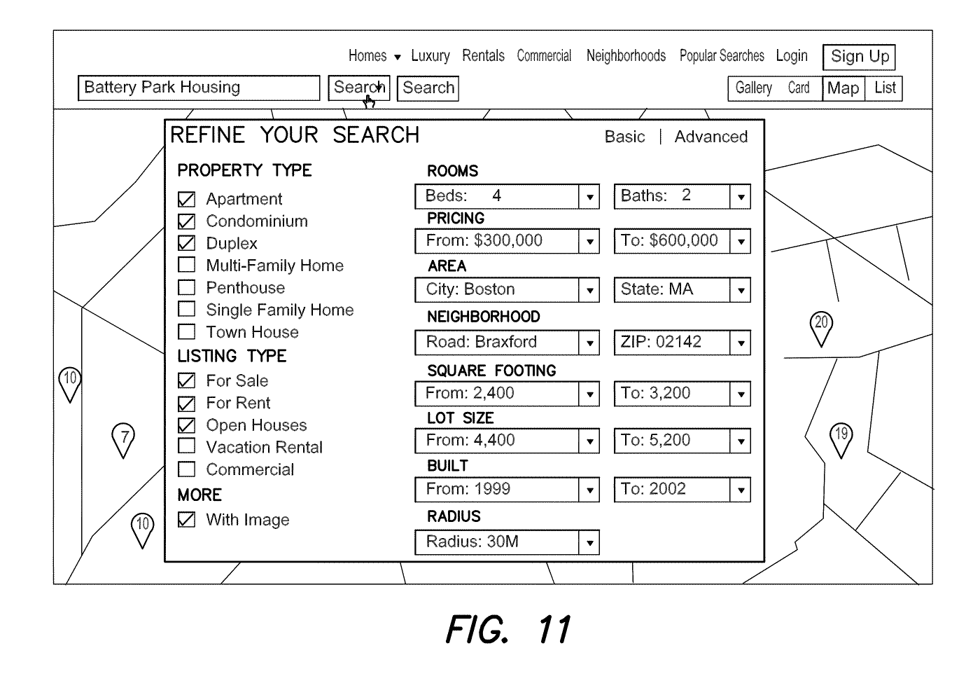

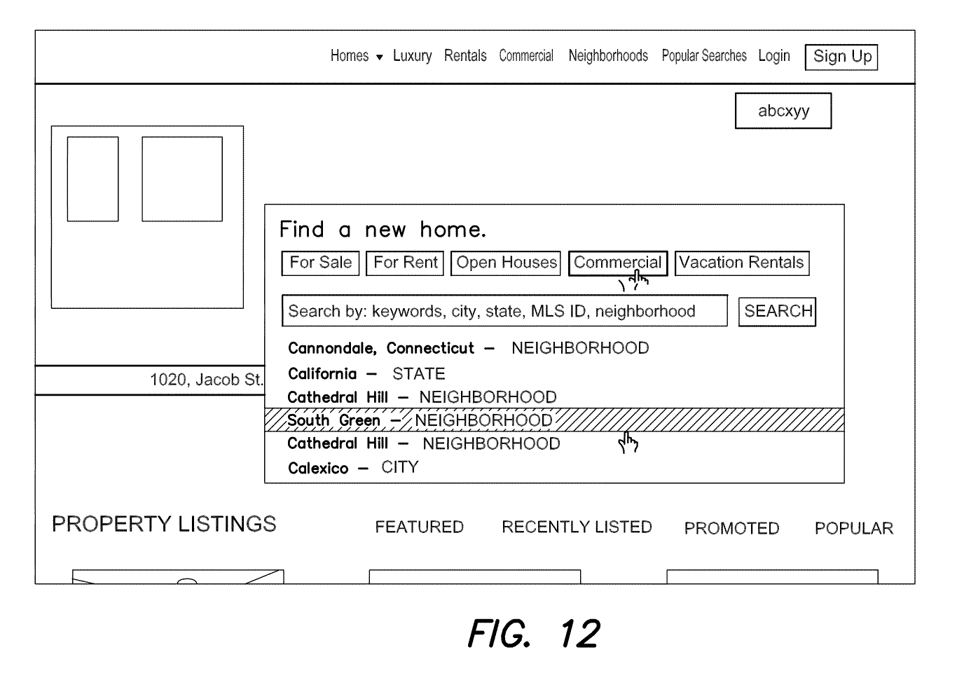

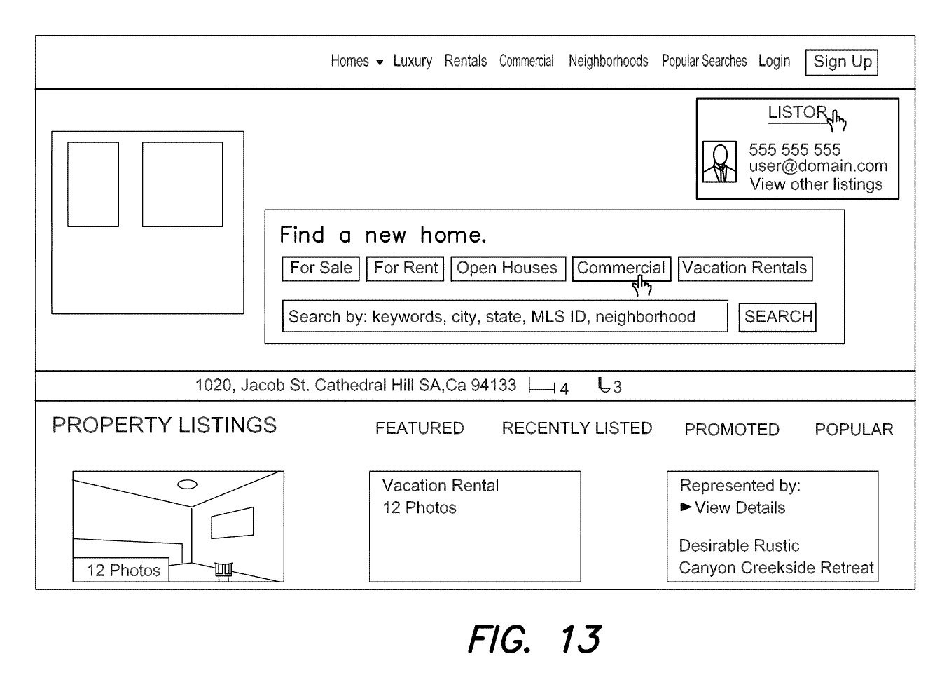

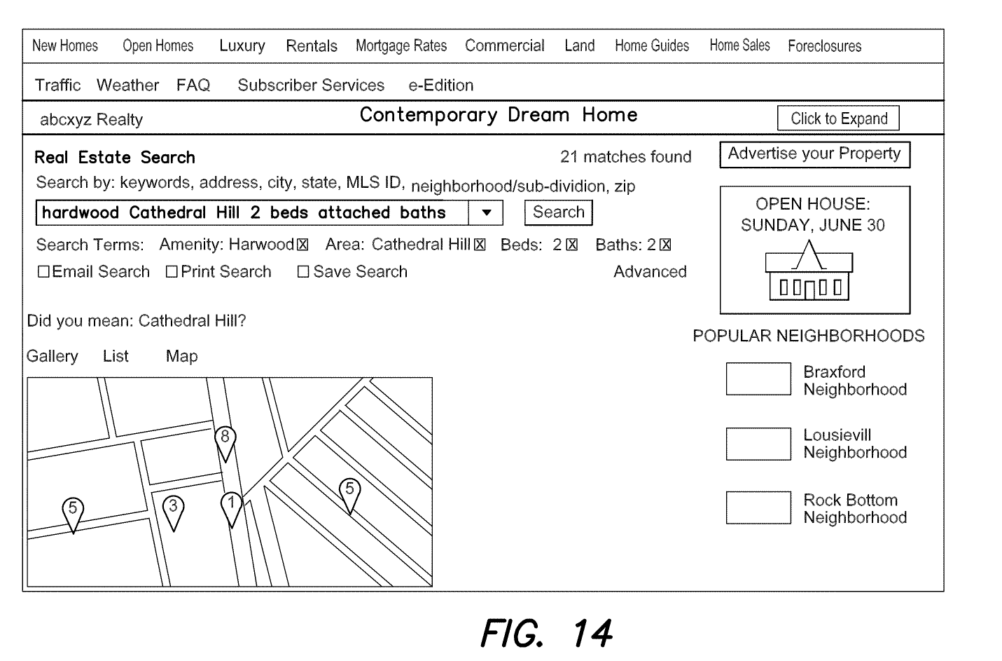

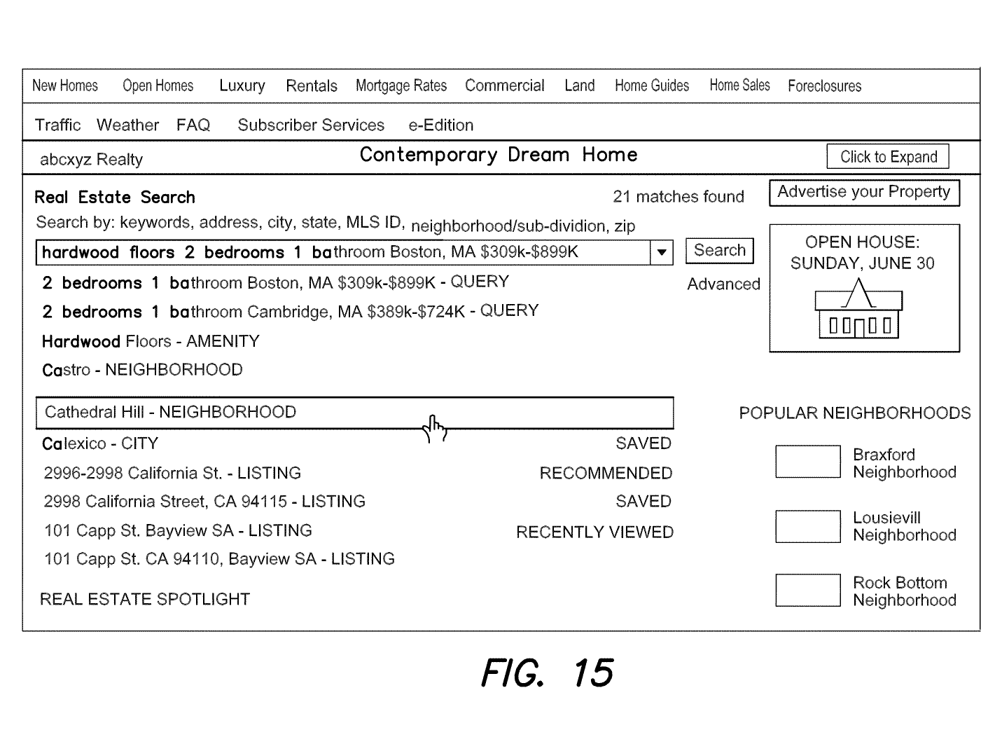

As discussed above, various embodiments of the system provide functions for accepting free text search, interpreting free text search, and delivering relevant search results. In some embodiments, user interfaces provided by the system are configured to simplify input of free text criteria and/or review returned results. Shown in FIGS. 9-15 are screen captures of example user interfaces. It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for entity based searching within a real estate database, the system comprising:
at least one processor operatively connected to a memory;
an interpreter component, executed by the at least one processor, configured to:
receive search information based on a free text input by a user, and
interpret the free text search information;
an analysis component configured to match data entities in the real estate database against the interpreted free text search information, wherein the data entities include at least a descriptor for real property and a value associated with the descriptor; and
wherein the at least one processor is further configured to constrain search execution within the real estate database based on the matched data entities and return results from properties having the matched data entities.

2. The system according to claim 1, wherein the interpreter component is further configured to identify a data entity and an associated value based on only free text.

3. The system according to claim 1, wherein the interpreter is configured to interpret a free text term to identify a data entity and a preferred value associated with the data entity.

4. The system according to claim 3, wherein the interpreter is further configured to identify a range of values associated with the data entity.

5. The system according to claim 1, further comprising a monitor component configured to monitor and record any user activity associated with a displayed website.

6. The system according to claim 5, wherein the monitor component is configured to communicate the user activity information to the interpreter component, and wherein the interpreter component is further configured to generate user intent associations to the data entities.

7. The system according to claim 5, wherein the monitor component further comprises a tracking user interface, and wherein the system presents the tracking user interface to the user for interacting with the system.

8. The system according to claim 7, wherein tracking user interface is configured to track all user interactions within any user interface display accessed by a user.

9. The system according to claim 1, further comprising a modeling component configured to generate data relationships between the data entities, users actions, and user models.

10. The system according to claim 9, wherein the modeling component is further configured to generate user behavioral models based on tracked user activity.

11. The system according to claim 10, wherein the modeling component is further configured to generate user or search intent relationships between user attributes and user behavior.

12. A method for entity based searching within a real estate database, the method comprising:
receiving, by a computer system, search information based on a free text input by a user;
interpreting, by the computer system, the free text search information;
matching, by the computer system data entities in the real estate database against the interpreted free text search information, wherein the data entities include at least a descriptor for real property and a value associated with the descriptor;
constraining, by the computer system, search execution within the real estate database based on the matched data entities; and
returning, by the computer system, results from properties having the matched data entities.

13. The method according to claim 12, wherein the method further comprises identifying a data entity and an associated value based on only free text.

14. The method according to claim 13, wherein interpreting includes an act of interpreting a free text term to identify a data entity and a preferred value associated with the data entity.

15. The method according to claim 14, further comprising identifying a range of values associated with the data entity.

16. The method according to claim 1, further comprising a monitoring, by the computer system, any user activity associated with a displayed website.

17. The method according to claim 13, wherein the act of monitoring includes communicating the user activity information and generating user intent associations to the data entities.

18. The method according to claim 17, further comprising tracking, by the computer system, user interface activity of the user and generating user intent associations to the data entities responsive to the tracked user interface activity.

19. The method according to claim 18, further comprising tracking all user interactions within any user interface display accessed by a user and associating the activity to a user intent model or a user behavior model.

20. The method according to claim 13, further comprising generating data relationships between the data entities, users' actions, and user identification models.

21. The method according to claim 21, wherein the method further comprises generating user behavioral models based on tracked user activity.

22. The method according to claim 10, further comprising generating user or search intent relationships between user attributes and user behavior.

23. A system for determining search intent, the system comprising:
at least one processor operatively connected to a memory;
a search analysis component, executed by the at least one processor, configured to:
receive any one or more of search information, returned results, and accessed results returned from a real estate database;
determine user intent based on the any one or more of search information, returned results, and accessed results;
correlate the user intent to data entities having respective values based on, wherein data entities include at least a descriptor for real property and a value associated with the descriptor; and
wherein the at least one processor is configured to modify subsequent search execution within the real estate database based on the user intent information.

24. The system according to claim 23, wherein the at least one processor is configured to assign a weight to a data entity responsive to the determination of the user intent.

25. The system according to claim 23, wherein the at least one processor is configured to interpret free text input into a data entity based at least in part on user intent information.

26. The system according to claim 25, wherein the at least one processor is configured to generate an interpretation rule for subsequent search execution.

27. The system according to claim 23, wherein the at least one processor is configured to assign a weight to a respective data entity and respective value associated with the data entity.

28. The system according to claim 23, further comprising a monitor component executed by the at least one processor configured to monitor and record any user activity associated with a displayed website.

29. The system according to claim 28, wherein the monitor component is configured to communicate the user activity information an interpreter component, and wherein the interpreter component is further configured to generate user intent associations to the data entities responsive to receiving the activity information.

30. The system according to claim 28, wherein the monitor component further comprises a tracking user interface, and wherein the system presents the tracking user interface to the user for accessing the system.

31. The system according to claim 30, wherein tracking user interface is configured to track all user interactions within any user interface display accessed by a user.

32. The system according to claim 23, further comprising a modeling component configured to generate data relationships between the data entities, users actions, behavior models, and user identity models.

33. The system according to claim 32, wherein the modeling component is further configured to generate user behavioral models based on tracked user activity.

34. The system according to claim 33, wherein the modeling component is further configured to generate user or search intent relationships between user attributes and user behavior.

35. A computer implemented method for determining search intent, the method comprising:
receiving, by a computer system, any one or more of search information, returned results, and accessed results returned from a real estate database;
determining, by the computer system, user intent based on the any one or more of search information, returned results, and accessed results;
correlating, by the computer system, the user intent to data entities having respective values based on, wherein data entities include at least a descriptor for real property and a value associated with the descriptor; and
modifying, by the computer system, subsequent search execution based on the user intent information.

36. The method according to claim 35, further comprising assigning a weight to a data entity responsive to the determination of the user intent.

37. The method according to claim 35, further comprising interpreting free text input into a data entity based at least in part on user intent information.

38. The method according to claim 37, further comprising generating an interpretation rule for subsequent search execution.

39. The method according to claim 35, further comprising assigning a weight to a respective data entity and respective value associated with the data entity.

40. The method according to claim 35, further comprising monitoring and recording any user activity associated with a displayed website.

41. The method according to claim 40, wherein monitoring includes communicating the user activity, and generating user intent associations to the data entities responsive to receiving the activity information.

42. The method according to claim 40, presenting tracking user interfaces to the user for accessing information.

43. The method according to claim 42, further comprising tracking all user interactions within any user interface display accessed by a user.

44. The method according to claim 35, further comprising generating data relationships between the data entities, users' actions, behavior models, and user identity models.

45. The method according to claim 35, further comprising generating user behavioral models based on tracked user activity.

46. The method according to claim 45, further comprising generating user or search intent relationships between user attributes and user behavior.
